(19) United States
(12) Patent Application Publication
(10) Pub. No.: US 2009/0061765 A1
(43) Pub. Date: Mar. 5, 2009

(54) Mobile terminal system and method for monitoring music program using music recognition

(75) Inventor: Hye Young Kim, Seoul (KR)

Correspondence Address: DOCKET CLERK, P.O. DRAWER 800889, DALLAS, TX, 75380, US

(73) Assignee: Samsung Electronics Co., Ltd., Suwon-si (KR)

(21) Appl. No.: 12/229,976

(22) Filed: Aug. 28, 2008

(30) Foreign Application Priority Data
Sep. 3, 2007 (KR) 2007-0089189

(51) Int. Cl. H04H 40/00; H04M 1/00

(52) U.S. Cl. 455/3.06; 455/556.1

(57) ABSTRACT

A mobile terminal, a system and a method for monitoring a music program using music recognition are provided. The mobile terminal includes: an input module for inputting, by a user, information of a music program to be monitored; a broadcast receiving module for receiving the input music program; a controller for periodically extracting an acoustic gene from the received music program; a wireless module for periodically transmitting the extracted acoustic gene to a music DB server through wireless communication and for receiving music information corresponding to the acoustic gene from the music DB server; and a display unit for displaying the received music information. Accordingly, a user can recognize information on a music list of a broadcast program and purchase desired music.

### CROSS-REFERENCE TO RELATED APPLICATION(S) AND CLAIM OF PRIORITY

This application claims priority to an application entitled “MOBILE TERMINAL, SYSTEM AND METHOD FOR MONITORING MUSIC PROGRAM USING MUSIC RECOGNITION” filed in the Korean Intellectual Property Office on Sep. 3, 2007 and assigned Serial No. 2007-0089189, the contents of which are incorporated herein by reference.

### TECHNICAL FIELD OF THE INVENTION

The present invention relates to a mobile terminal, a system and a method for monitoring a music program using music recognition and, more particularly, to a mobile terminal, a system and a method for monitoring a music program to effectively create a list of broadcast music using music recognition and wireless communication.

### BACKGROUND OF THE INVENTION

Music recognition is a technology for recognizing music by searching a unique characteristic (that is, an ‘acoustic gene’) of music or a sound source, and providing information on music, such as a music title, a singer, a composer, a conductor and an album title. The acoustic gene may be referred to as a kind of audio fingerprinting of a sound. The acoustic gene is called an audio DNA or a feature vector, and refers to a characteristic used for recognizing a sound, such as a unique audio fingerprint or gene of the sound. The acoustic gene for the music recognition is obtained through a process of sampling a sound for a specified time and a process of extracting a characteristic from the sampled sound. In the sampling process, a broadcast receiving module receives a broadcast, and an audio signal therefrom is sampled and recorded at a specified sampling frequency (for example, 44.1 kHz) and for a specified time (for example, 10 seconds). In the extracting process, the sampled sound is signal-processed in time or in frequency domain by filtering, wave transformation, amplification or attenuation.

Typically, the music recognition uses a database (DB) server. That is, the DB server stores music information and acoustic gene information. The DB server receives an acoustic gene of music from a user and provides music information corresponding to the acoustic gene to the user. The user may communicate with the DB server by wireless or cable communication.

A conventional mobile terminal may provide a radio function, a TV function and a mobile TV broadcasting function, and thus, a user can view or listen to an interesting broadcast program through the mobile terminal. In the case that the user misses a title of music in which they are interested during the program, the user may obtain information on the music via the DB server through the sampling process for the music.

However, the conventional technology cannot be applied when a user does not listen to or view a broadcast program. That is, the conventional technology is applicable to music only when the user selects a specified broadcast such as a radio broadcast in a mobile terminal and listens to a music program. Thus, the user can obtain information on a piece of music by performing a music recognition function for the desired music only while listening to or viewing a broadcast program.

Further, in the case that a user wants to receive a list of all music in one broadcast program by monitoring the whole broadcast program in real time, the user should perform the music recognition function repeatedly for each music played during the broadcast program.

### SUMMARY OF THE INVENTION

To address the above-discussed deficiencies of the prior art, it is a primary object to provide a mobile terminal, a system and a method for creating a real-time list of a broadcast music program using music recognition and wireless communication even in the case that a user does not view or listen to the music program.

In an exemplary embodiment of the present invention, a mobile terminal includes: an input module for inputting, by a user, an information of a music program to be monitored; a broadcast receiving module for receiving the input music program; a controller for periodically extracting an acoustic gene from the received music program; a wireless module for periodically transmitting the extracted acoustic gene to a music DB server through a wireless communication and for receiving a music information corresponding to the acoustic gene from the music DB server; and a display unit for displaying the received music information.

In another exemplary embodiment of the present invention, a music program monitoring system includes: a mobile terminal, wherein the mobile terminal includes: an input module for inputting, by a user, an information of a music program to be monitored, a broadcast receiving module for receiving the input music program, a controller for periodically extracting an acoustic gene from the received music program, a wireless module for periodically transmitting the extracted acoustic gene to a music DB server through a wireless communication and for receiving a music information corresponding to the acoustic gene from the music DB server, and a display unit for displaying the received music information; and a music DB server, wherein the music DB server includes: a server wireless module for periodically receiving the extracted acoustic gene through the wireless communication from the wireless module of the mobile terminal and for transmitting corresponding music information thereto, an acoustic gene database (DB) module for storing and retrieving relationships between a plurality of acoustic genes and the corresponding music information, and a server controller for receiving the extracted acoustic gene through the server wireless module, for transmitting the acoustic gene to the acoustic gene DB module, and for transmitting corresponding a music information retrieved by the acoustic gene DB module to the server wireless module.

In another exemplary embodiment of the present invention, a method for monitoring a music program using an acoustic gene includes: receiving an input information of the music program to be monitored from a user using a mobile terminal; receiving the input music program; processing the received music program and periodically extracting the acoustic gene; periodically transmitting the extracted acoustic gene to a music DB server through a wireless communication and receiving a music information corresponding to the acoustic gene from the music DB server; and displaying the received music information to the user.

According to the present invention, a user may obtain specific information on a list of music of a broadcast music program and on corresponding music, irrespective of whether the user listens to the music program or not. Further, the user may purchase desired music through wireless communication.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a block diagram illustrating a configuration of a mobile terminal according to an exemplary embodiment of the present invention;

FIG. 2 is a block diagram illustrating a configuration of a music program monitoring system including a mobile terminal and a music DB server according to another exemplary embodiment of the present invention;

FIG. 3 is a flowchart illustrating a method for monitoring a music program according to another exemplary embodiment of the present invention;

FIG. 4 illustrates a screen of a mobile terminal displaying a menu for monitoring a music program while listening to a radio of the mobile terminal in the method of FIG. 3; and

FIG. 5 is a screen of a mobile terminal illustrating a list of broadcast music created through the music program monitoring method of FIG. 3.

### DETAILED DESCRIPTION OF THE INVENTION

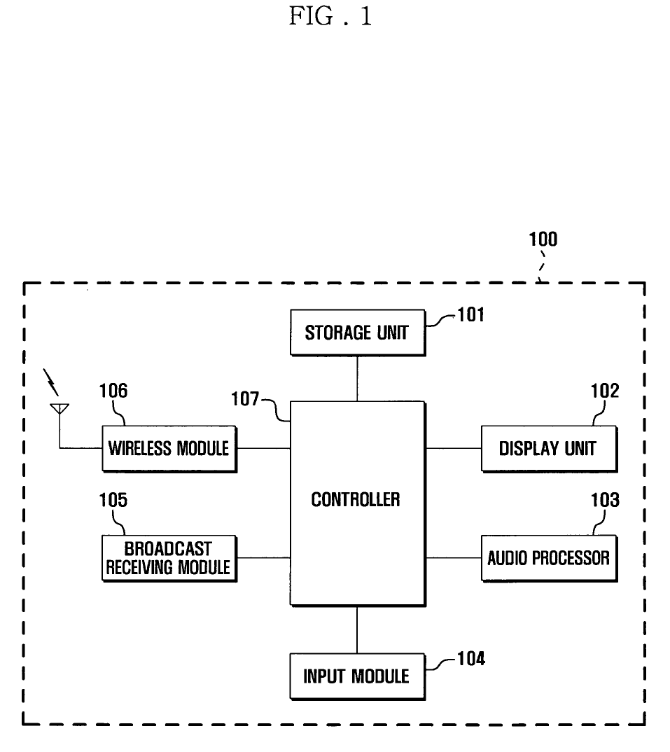

FIGS. 1 through 5, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged wireless music recognition system.

In the following embodiments, a mobile terminal may be a variety of electronic devices, such as a mobile phone, a digital broadcasting terminal, a personal digital assistant, a smart phone and an MP3 player.

A schematic configuration of an apparatus for monitoring music broadcasting according to an exemplary embodiment of the present invention is described hereinafter. FIG. 1 is a block diagram illustrating a schematic configuration of a mobile terminal according to the exemplary embodiment of the present invention.

Referring to FIG. 1, a mobile terminal 100 includes an input module 104, a broadcast receiving module 105, an audio processor 103, a controller 107, a wireless module 106, a display unit 102, and a storage unit 101.

The input module 104 receives various input signals from a user and outputs corresponding signals to the controller 107. The input signals received from the user are used for various functions of the mobile terminal 100 or used as parameters of the functions. The input module 104 may receive, from the user, information of a music program to be monitored, including various input values, such as name and time information on the music program to be monitored, an extracting interval for an acoustic gene and an accessing interval for a music DB server. The input module 104 may be various devices, such as a key pad, a touch pad and a touch screen.

The time information on a music program includes information such as a start time, a finish time and a running time of the specific program.

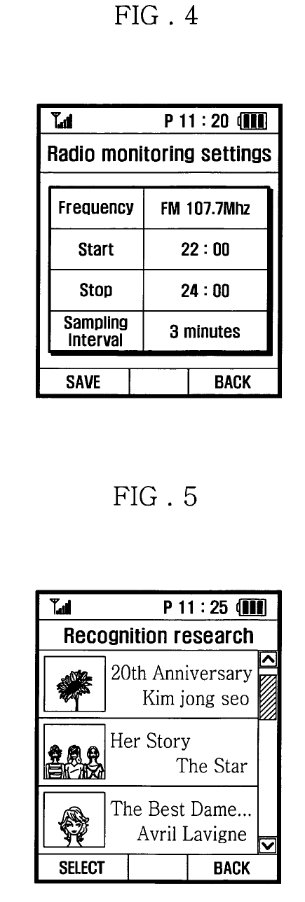

The input module 104 may also receive information about a music program from the user in a form of a frequency of a broadcasting channel or a title of a program, for example KBS 1 FM. In the case that the user activates a music program monitoring function while listening to or viewing a broadcast program, it is assumed that the user intends to monitor the music program on the air. In this case, the user monitors the music program currently on the air without receiving another music program. FIG. 4 illustrates a screen of the mobile terminal 100 displaying a menu for providing a parameter value for monitoring a music program while listening to a radio of the mobile terminal 100.

The broadcast receiving module 105 receives a broadcast program transmitted from a broadcasting station. The broadcast program may be a TV broadcast program, a radio broadcast program or a mobile TV broadcast program. Specifically, the present invention relates to music broadcasting. The broadcast receiving module 105 receives a signal of a broadcast program to be monitored by a user among broadcast signals transmitted from a plurality of broadcasting stations through a tuner having an antenna, and demodulates an audio signal or an audio and a video signals, thereby removing a carrier wave from the received broadcast signal. The broadcast receiving module 105 outputs the audio and video signals directly to the audio processor 103 and the display unit 102, or outputs the audio and video signals to the audio processor 103 and the display unit 102 through the controller 107. The broadcast receiving module 105 has a different configuration according to a type of broadcast receiving equipment, such as a TV, a radio and a mobile TV.

The audio processor 103 processes an audio signal in the music program received by the broadcast receiving module 105. When a user listens to a radio broadcast program, the broadcast receiving module 105 outputs the demodulated audio signal to the audio processor 103 in real time. When the user views a TV broadcast program or a mobile TV broadcast program, the broadcast receiving module 105 outputs the demodulated audio and video signals to the audio processor 103 and the display unit 102, respectively, in real time. Typically, the audio processor 103 includes an integrated speaker, an earphone or a wireless headset. Further, an audio processor may include a mono speaker and a stereo speaker. If the user monitors music in a background mode, the mobile terminal 100 monitors the music in the background mode while performing other operations in a foreground mode. Thus, the controller 107 does not output the audio signal and the video signal of the broadcast program received through the broadcast receiving module 105 to the audio processor 103 and the display unit 102. That is, the controller 107 monitors the music program in the background mode while controlling the audio signal and the video signal.

The controller 107 periodically extracts an acoustic gene from the music program received through the broadcast receiving module 105 and stores the acoustic gene in the storage unit 101. The acoustic gene is known by various names, such as an audio gene or a characteristic vector, and refers to a characteristic used for recognizing a sound, thereby acting as a unique fingerprint or gene of the sound. The acoustic gene for the music recognition is obtained through processes of sampling a sound for a predetermined time interval and extracting a characteristic from the sampled sound. In the sampling process, the controller 107 samples and records the audio signals received from the broadcast receiving module 105 using a specific sampling frequency (for example, 44.1 kHz) and during a specific time interval (for example, 10 seconds). In the extracting process, the sampled sound signals are processed in time or in frequency domain (for example, by filtering, wave transformation, amplification or attenuation).

The extracting interval for the acoustic gene is input by the user. If a plurality of pieces of music flow continuously in a music program, a reproducing time of each piece of music may differ, and advertisements or comments of a presenter may be placed between the pieces of music. In this situation, a conventional method of sensing a start of each piece of music requires a complex algorithm. However, the present invention provides a method for extracting an acoustic gene for a specific time interval input by the user. Typically, a length of one piece of music is about 2 to 6 minutes. The extracting interval for the acoustic gene is preferably shorter than intervals of play of the pieces of music in the broadcast program. If the extracting interval for the acoustic gene is shorter than the intervals of play of the pieces of music in the broadcast program, all pieces of music from the broadcast program can be monitored. However, a workload of the mobile terminal is heavy, and the mobile terminal should frequently access a music DB server. If the extracting interval for the acoustic gene is longer than the intervals of play of the pieces of music flow in the broadcast program, the workload of the mobile terminal is lighter, and the mobile terminal does not need to frequently access the music DB server. However, a piece of music from the broadcast program may be missed.

Further, if the extracting period for the acoustic gene is relatively short, a piece of music may be repeatedly monitored. This problem can be solved by searching for a piece of music based on music information obtained from the music DB server and then deleting identical pieces of music.

The wireless module 106 periodically transmits the acoustic gene extracted by the controller 107 to the music DB server through wireless communication and receives music information corresponding to the acoustic gene from the music DB server. The music information is a kind of metadata of music and may include, for example, a music title, musician name, album title, music list of the album, music genre, and a picture of the album. The use of an ID3 tag is standard in a compressed audio file such as MP3, and may be an ID3v1 tag or an ID3v2 tag. The ID3v1 tag contains information such as a track, title, artist, album title, music genre and related details; and the ID3v2 tag contains information such as a composer, lyrics, original artist, copyright holder, and a uniform resource locator (URL). The music information may be in a format defined in a standard such as an ID3 tag or another format defined separately.

Wireless communication method of the wireless module 106 may be a method such as CDMA (code division multiple access), GSM (global system for mobile telecommunication) or GPRS (general packet radio service). The wireless communication method of the wireless module 106 may use a protocol, such as WAP (wireless application protocol), for an SMS (short messaging system) or MMS (multimedia messaging system).

A communication period of the wireless module 106 with the music DB server may be an extracting interval for the acoustic gene, an interval starting and ending at the start and end time, respectively, of the music program, or a interval input by the user. The quantity of the acoustic genes transmitted by the wireless module 106 may be singular or multiple according to the communication period of the wireless module 106 with the music DB server. If the communication period is identical to the extracting interval for the acoustic gene, the processes of extracting the acoustic gene by the controller 107 and communicating with the music DB server by the wireless module 106 are performed consecutively. First, the controller 107 extracts the acoustic gene, and then the wireless module 106 communicates with the music DB server. In this case, the quantity of the acoustic genes transmitted by the wireless module 106 is one. Next, if the communication period is set as starting and ending at the start and end time, respectively, of the music program, the wireless module 106 transmits at least one acoustic gene stored in the storage unit 101 to the music DB server after the music program to be monitored terminates, and receives at least one music information corresponding to the at least one acoustic gene from the music DB server.

The display unit 102 displays various information (such as music information) to the user. The display unit 102 may include an LCD (liquid crystal display) or LED (light emitting diode) display.

The storage unit 101 stores a program, data and a parameter required for the program. The storage unit 101 stores an acoustic gene required when the wireless module 106 communicates with the music DB server. The storage unit 101 also stores music information that the wireless module 106 retrieves from the music DB server through wireless communication.

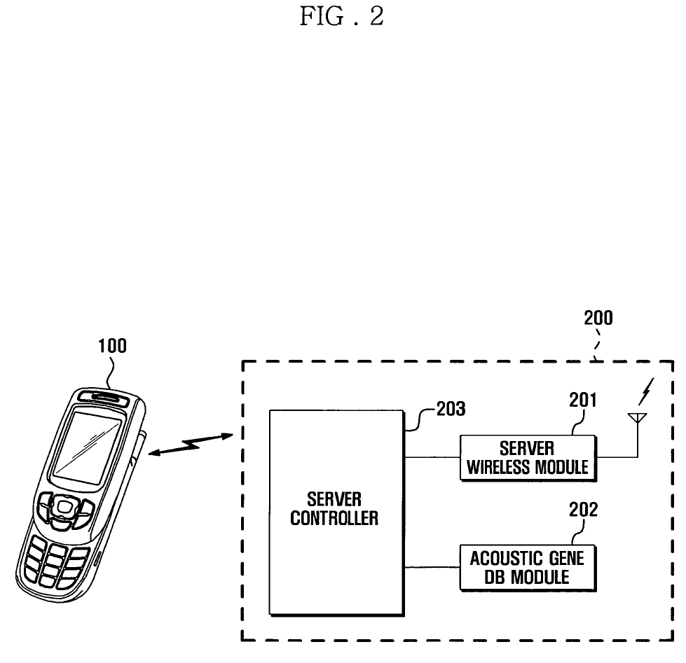

Hereinafter, a music broadcasting monitoring system according to another exemplary embodiment of the present invention is described. FIG. 2 is a block diagram illustrating a configuration of the music program monitoring system having a mobile terminal and a music DB server according to the exemplary embodiment.

Referring to FIGS. 1 and 2, the music broadcasting monitoring system includes the wireless communication terminal 100, as described above, and a music DB server 200.

The music database server 200 includes a server wireless module 201, an acoustic gene DB module 202, and a server controller 203.

The server wireless module 201 periodically receives an acoustic gene from the wireless module 106 of the mobile terminal 100, and transmits music information corresponding to the acoustic gene to the wireless module 106 through wireless communication. Wireless communication method of the server wireless module 201 may be a method such as CDMA, GSM or GPRS. The wireless communication method of the server wireless module 201 may use a protocol, such as WAP, for an SMS or MMS.

The acoustic gene DB module 202 stores and searches for relationships between a plurality of acoustic genes and music information. That is, the acoustic gene DB module 202 stores acoustic genes corresponding to a plurality of pieces of music, and a database for music information, including music information corresponding to the plurality of pieces of music. The acoustic gene received by the server wireless module 201 is transmitted to the acoustic gene DB module 202 under the control of the server controller 203. The acoustic gene DB module 202 searches for music corresponding to the received acoustic gene. Upon identifying the corresponding music, the stored music information related to the music is retrieved by the acoustic gene DB module 202 and output to the server controller 203. As previously described, the music information may have various formats.

The server controller 203 receives the acoustic gene transmitted by the mobile terminal 100 from the server wireless module 201 and outputs the acoustic gene to the acoustic gene DB module 202. The server controller 203 receives the corresponding music information from the acoustic gene DB module 202, and outputs the music information to the server wireless module 201. The server controller 203 controls wireless communication of the music DB server 200 to the mobile terminal 100 as well as the storage and search of the database for the acoustic gene.

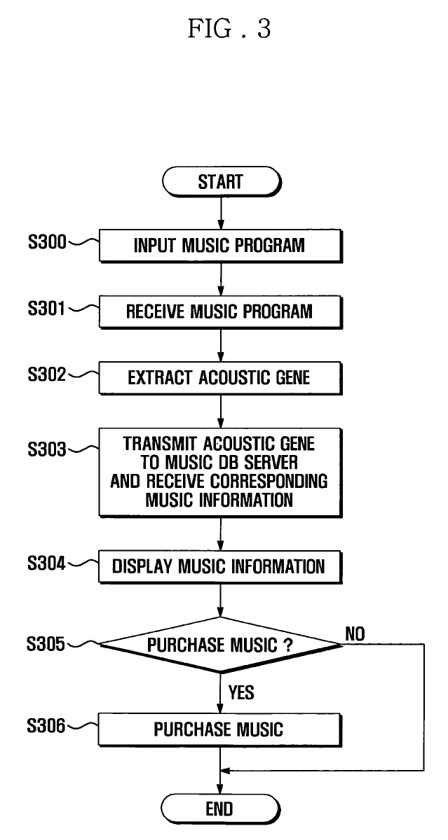

FIG. 3 is a flowchart illustrating a method for monitoring a music program using an acoustic gene according to another exemplary embodiment of the present invention.

Referring to FIG. 3, a user inputs a desired music program to be monitored through the input module 104 of the mobile terminal 100 (S300). The music program may be input in a format of a frequency of the broadcast channel or a title of the program (for example, KBS 1 FM). However, in the case that the user activates a music program monitoring function while listening to or viewing a broadcast program, it is assumed that the user intends to monitor the music program on the air. In this case, the user monitors the music program on the air without receiving another music program. FIG. 4 illustrates a screen of the mobile terminal 100 displaying a menu for monitoring a music program while listening to a radio of the mobile terminal 100 in the method of FIG. 3.

The user also inputs parameters for monitoring the music program through the input module 104, such as time information on the music program, an extracting interval for an acoustic gene, and an access interval for the music DB server 200.

Next, the broadcast receiving module 105 receives the input music program among programs transmitted by a broadcasting station (S301). That is, a broadcast signal of the frequency of the music program to be monitored is received through an antenna and a tuner, and audio and video signals are demodulated. The broadcast program may be a TV broadcast program, a radio broadcast program or a mobile TV broadcast program.

The controller 107 processes the received music program and periodically extracts an acoustic gene (S302). The extracted acoustic gene is stored in the storage unit 101. The acoustic gene for music recognition is obtained through processes of sampling a sound for a predetermined time interval and extracting a characteristic from the sampled sound. The quantity of the extracted acoustic genes may be singular or multiple according to a communication period of the wireless module 106 with the music DB server 200.

Next, the extracted acoustic gene is periodically transmitted to the music DB server 200 by the wireless module 106 through wireless communication, and music information corresponding to the acoustic gene is received from the music DB server 200 (S303). The music information is a kind of metadata of music and may include, for example, a music title, musician name, album title, music list of the album, music genre, and a picture of the album. The music information may be in a format defined in a standard such as an ID3 tag or another format defined separately. The music information is retrieved from storage by the acoustic gene DB module 202 of the music DB server 200 and transmitted to the mobile terminal 100 through wireless communication. The received music information is displayed to the user through the display unit 102 and is stored in the storage unit 101 (S304).

FIG. 5 is a screen of a mobile terminal illustrating a list of broadcasted music created through the music program monitoring method of FIG. 3. FIG. 5 illustrates a list of music played in a music program including information such as an album picture, a music title and a musician name. If the user selects a music title, a variety of information corresponding to the selected music may be provided to the user. If the user selects an album picture or musician name, various information about the album or the musician name may be provided to the user. For example, if the user selects the album picture, music information about other music in the album may be provided to the user. The user can view a list of the music programs being monitored using the music information corresponding to the music. The user can also purchase music through a convenient interface by accessing the music DB server 200 or a separate server through wireless communication to purchase the corresponding music directly.

Referring to FIG. 3, the controller 107 determines whether the user requests to purchase the music corresponding to the displayed music information (S305).

If the user requests to purchase the music, the mobile terminal 100 accesses the music DB server 200 through wireless communication and purchases the music (S306).

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A mobile terminal comprising:
an input module for inputting, by a user, an information of a music program to be monitored;
a broadcast receiving module for receiving the input music program;
a controller for periodically extracting an acoustic gene from the received music program;
a wireless module for periodically transmitting the extracted acoustic gene to a music database server through a wireless communication and for receiving a music information corresponding to the acoustic gene from the music database server; and
a display unit for displaying the received music information.

2. The mobile terminal according to claim 1, wherein the information input to the input module comprises a time information on the music program to be monitored, an extracting interval for the acoustic gene and an accessing interval for the music database server.

3. The mobile terminal according to claim 2, wherein the accessing interval for the music database server comprises one of the extracting interval for the acoustic gene, an interval starting and ending at a start and an end time, respectively, of the music program and an interval input by the user.

4. The mobile terminal according to claim 1, wherein the music information comprises at least one of a music title, a musician name, a music album title, a music list on the music album, a music genre, and a picture of the music album.

5. The mobile terminal according to claim 1, wherein the controller accesses, if the user requests to purchase music corresponding to the music information displayed on the display unit, the music database server to purchase the requested music.

6. The mobile terminal according to claim 1, wherein the music program comprises one of a television broadcast program, a radio broadcast program and a mobile television broadcast program.

7. A music program monitoring system comprising:
a mobile terminal, wherein the mobile terminal comprises:
an input module for inputting, by a user, an information of a music program to be monitored,
a broadcast receiving module for receiving the input music program,
a controller for periodically extracting an acoustic gene from the received music program,
a wireless module for periodically transmitting the extracted acoustic gene to a music database server through a wireless communication and for receiving a music information corresponding to the acoustic gene from the music database server, and
a display unit for displaying the received music information; and
a music DB server, wherein the music DB server comprises:
a server wireless module for periodically receiving the extracted acoustic gene through the wireless communication from the wireless module of the mobile terminal and for transmitting a corresponding music information thereto,
an acoustic gene database module for storing and retrieving relationships between a plurality of acoustic genes and the corresponding music information, and
a server controller for receiving the extracted acoustic gene through the server wireless module, for transmitting the acoustic gene to the acoustic gene database module, and for transmitting the corresponding music information retrieved by the acoustic gene database module to the server wireless module.

8. The system according to claim 7, wherein the information input to the input module comprises a time information on the music program to be monitored, an extracting interval for the acoustic gene and an accessing interval for the music database server.

9. The system according to claim 8, wherein the accessing interval for the music DB server comprises one of the extracting interval for the acoustic gene, an interval starting and ending at a start and an end time, respectively, of the music program and an interval input by the user.

10. The system according to claim 7, wherein the music information comprises at least one of a music title, a musician name, a music album title, a music list on the music album, a music genre, and a picture of the music album.

11. The system according to claim 7, wherein the wireless module accesses, if the user requests to purchase music corresponding to the music information displayed on the display unit, the music database server to purchase the requested music.

12. The system according to claim 7, wherein the music program comprises one of a television broadcast program, a radio broadcast program and a mobile television broadcast program.

13. A method for monitoring a music program using an acoustic gene, the method comprising:
receiving an input information of a music program to be monitored from a user using a mobile terminal;
receiving the input music program;
processing the received music program and periodically extracting an acoustic gene;
periodically transmitting the extracted acoustic gene to a music database server through a wireless communication;
receiving a music information corresponding to the acoustic gene from the music database server; and
displaying the received music information to the user.

14. The method according to claim 13, further comprising receiving a time information on the music program to be monitored, an extracting interval for the acoustic gene and an accessing interval for the music database server from the user.

15. The method according to claim 14, wherein the accessing interval for the music DB server comprises one of the extracting interval for the acoustic gene, an interval starting and ending at a start and an end time, respectively, of the music program and an interval input by the user.

16. The method according to claim 13, wherein the music information comprises at least one of a music title, a musician name, a music album title, a music list on the music album, a music genre, and a picture of the music album.

17. The method according to claim 13, wherein receiving the input music program, processing the received music program and periodically extracting the acoustic gene, periodically transmitting the extracted acoustic gene, and receiving music information corresponding to the acoustic gene are performed in a background mode of the mobile terminal.

18. The method according to claim 13, wherein the music program comprises one of a television broadcast program, a radio broadcast program and a mobile television broadcast program.
